(19) United States
(12) Patent Application Publication
(10) Pub. No.: US 2007/0238832 A1
(43) Pub. Date: Oct. 11, 2007

(54) METHOD OF MAKING A POLY(ARYLENE ETHER)/POLYAMIDE COMPOSITION

(75) Inventors: Pravin Borade, Maharashtra (IN); Manatesh Chakraborty, Maharashtra (IN); Parnasree Maiti, West Bengal (IN)

Correspondence Address: CANTOR COLBURN, LLP, 55 GRIFFIN ROAD SOUTH, BLOOMFIELD, CT, 06002, US

(73) Assignee: General Electric Company, Schenectady, NY (US)

(21) Appl. No.: 11/278,724

(22) Filed: Apr. 5, 2006

(51) Int. Cl. C08L 77/00

(52) U.S. Cl. 525/66

(57) ABSTRACT

A method of making a thermoplastic composition comprises melt blending a poly(arylene ether), a compatibilizer and a second impact modifier to form a first mixture. The second impact modifier comprises aryl alkylene units. The first mixture is melt blended with polyamide, electrically conductive carbon black. A first impact modifier and fibrous filler.

### BACKGROUND OF INVENTION

Described herein is an electrically conductive thermoplastic composition comprising poly(arylene ether) and polyamide.

Compatibilized blends of poly(arylene ether) and polyamide have been employed in a wide range of applications. In recent years use of these blends in automotive applications, particularly in body panels, has increased. Thermoplastic body panels are lighter than metal body panels, which can result in improved gas mileage. Additionally, thermoplastic body panels do not rust and are dent resistant. In many cases it is desirable for the thermoplastic body panel to be sufficiently electrically conductive and have adequate heat resistance so the body panel can be painted using an electrostatic painting system.

Despite recent advances there remains a need for an electrically conductive thermoplastic composition with improved physical properties and methods of making these compositions.

### BRIEF DESCRIPTION OF THE INVENTION

A method of making a thermoplastic composition comprises melt blending a poly(arylene ether), a compatibilizer and a second impact modifier to form a first mixture. The second impact modifier comprises aryl alkylene units. The first mixture is melt blended with a polyamide, a first masterbatch, and a second masterbatch. The first masterbatch comprises polyamide and electrically conductive carbon black. The second masterbatch comprises polyamide, a first impact modifier and fibrous filler. The first impact modifier comprises at least two moieties selected from the group consisting of carboxylic acid, anhydride, epoxy, oxaziline and ester and is essentially free of aryl alkylene units. The fibrous filler is selected from the group consisting of carbon fibers, glass fibers, carbon nanotubes and combinations of two or more of the preceding fibrous fillers.

In one embodiment a method of making a thermoplastic composition comprises melt blending a poly(arylene ether), a compatibilizer and a second impact modifier comprising aryl alkylene units to form a first mixture. The first mixture is melt blended with a polyamide and a masterbatch to form a second mixture. The masterbatch comprises polyamide, a first impact modifier essentially free of aryl alkylene a units and comprising at least two moieties selected from the group consisting of carboxylic acid, anhydride, epoxy, oxazoline and ester, and a fibrous filler selected from the group consisting of carbon fillers, carbon nanotubes, glass fibers, and combinations of two or more of the foregoing fibrous fillers. The second mixture is melt blended with electrically conductive carbon black.

### BRIEF DESCRIPTION OF THE DRAWING

FIG. 1 is a schematic representation of an automotive fender.

### DETAILED DESCRIPTION

The terms “first,” “second,” and the like, “primary,” “secondary,” and the like, as used herein do not denote any order, quantity, or importance, but rather are used to distinguish one element from another.

The terms “a” and “an” do not denote a limitation of quantity, but rather denote the presence of at least one of the referenced items.

“Optional” or “optionally” means that the subsequently described event or circumstance may or may not occur, and that the description includes instances where the event occurs and instances where it does not.

In some applications it is desirable to have a conductive thermoplastic composition which has a coefficient of thermal expansion similar to the coefficient of thermal expansion of a metal component. For example, an automotive body frame is primarily composed of metal and some or all of the body panels may be composed of thermoplastic. It is desirable for the frame and body panels to be painted together. The painting process can include heating and cooling steps during which the metal and thermoplastic expand and contract. If the expansion and contraction of the two different materials is substantively different then defects such as buckling and warpage can occur.

The mean coefficient of thermal expansion, as used herein, is the mean coefficient of thermal expansion in the flow direction. Flow direction is defined as the direction in which the majority of the molten thermoplastic composition moves when injection molding the sample(s) employed in mean coefficient of thermal expansion testing. In one embodiment the thermoplastic composition has a mean coefficient of thermal expansion (CTE) of less than or equal to 6.0×10⁻⁵° C.⁻¹. Within this range the CTE may be less than or equal to 5.5×10⁻⁵° C.⁻¹, or, more specifically, less than or equal to 5.0×10⁻⁵° C.⁻¹. The CTE may be greater than or equal to 1.0×10⁻⁶° C.⁻¹.

The mean coefficient of thermal expansion (CTE) is measured in the flow direction according to ISO 11359-2 with the use of a thermal mechanical analyzer (TMA). The testing specimens are made by injection molding and then are cut to a size of 9 millimeters (mm)×9 mm×4 mm wherein each of the foregoing dimensions can be plus or minus 1 mm. The testing specimens are annealed at a temperature 30° C. below the glass transition temperature of the poly(arylene ether) in the first heating cycle and the expansion is recorded in the second heating cycle. The CTE is determined over a temperature range of 23° C. to 60° C.

Additionally, the thermoplastic composition has high impact strength. Impact strength may be measured using the Notched Izod (NI) impact test in accordance with ISO 180/1A at 23° C. using specimens having dimensions of 80 mm×10 mm×4 mm. A 5.5 Joule (J) hammer weight is allowed to freely fall to break the clamped notched samples with the notch facing the hammer. Prior to testing the specimens are conditioned at 23° C. and 50% relative humidity for 16 hours or more in accordance with ISO 291. Impact strength values are the arithmetic mean of at least 5 samples. In some embodiments the thermoplastic composition has a NI value greater than or equal to 10 kilojoules per square meter (kJ/m²), or, more specifically, greater than or equal to 10.2 kJ/m², or, even more specifically, greater than or equal to 10.8 kJ/m² when determined at 23° C. The thermoplastic composition may have a NI value less than or equal to 75 kJ/m².

Previous attempts to form poly(arylene ether)/polyamide blends with CTE values less than 7×10⁻⁵° C.⁻¹ have typically involved the inclusion of significant amounts of particulate fillers such as talc. Inclusion of large amounts of particulate fillers alone, while successful in reducing the CTE, also reduced the impact strength of the compositions, thus limiting their usefulness. For example, when talc is incorporated in sufficient amounts to attain a CTE of about 5×10⁻⁵° C.⁻¹ the Notched Izod value is less than 5 kJ/m².

Specific volume resistivity (SVR) is a measure of the leakage current through a volume of material. It is defined as the electrical resistance through a one-centimeter cube of material and is expressed in ohm-centimeter (ohm-cm). The lower the specific volume resistivity of a material, the more conductive the material is. In one embodiment the thermoplastic composition has a specific volume resistivity less than or equal to 10⁶ ohm-cm, or, more specifically, less than or equal to 10⁵ ohm-cm, or, even more specifically, less than or equal to 10⁴ ohm-cm. The specific volume resistivity may be greater than or equal to 1 ohm-cm. Specific volume resistivity may be determined as described in the Examples.

In one embodiment the thermoplastic composition has a Vicat B/120 greater than or equal to 170° C., or, more specifically, greater than or equal to 175° C., or, even more specifically, greater than or equal to 180° C. Vicat B/120 is determined using ISO 306 standards. A Vicat B/120 greater than or equal to 170° C. is indicative that the composition has adequate heat performance for electrostatic coating. The composition may have a Vicat B/120 value less than or equal to 230° C.

In one embodiment, the composition has a melt viscosity at 1500 seconds⁻¹ and a temperature of 282° C. of less than or equal to 240, or, more specifically, less than or equal to 225, or, even more specifically, less than or equal to 220 Pascals-seconds as determined by multipoint capillary rheometry. The melt viscosity may be greater than or equal to 50 Pascal-seconds.

In one embodiment, the composition has a nominal tensile strain at break greater than or equal to 8% as determined by ISO 527-2. The nominal tensile strain at break may be less than or equal to 30%. Nominal tensile strain at break is determined using at least 5 type 1A samples made by injection molding. Prior to testing the samples were conditioned at 23° C. and 50% relative humidity for 48 hours. The samples were tested at 23° C. and 50% relative humidity using a testing speed of 50 millimeters per minute.

The terms “a” and “an” herein do not denote a limitation of quantity, but rather denote the presence of at least one of the referenced item. All ranges disclosed herein are inclusive and combinable (e.g., ranges of “up to 25 wt %, or, more specifically, 5 wt % to 20 wt %,” is inclusive of the endpoints and all intermediate values of the ranges of “5 wt % to 25 wt %,” etc.). The terms “first” and “second” as used herein are for identification purposes only and do not imply an order of addition.

As used herein, a “poly(arylene ether)” comprises a plurality of structural units of the formula (I): 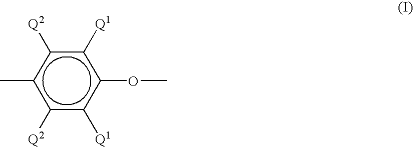
wherein for each structural unit, each Q¹ and each Q² is independently hydrogen, halogen, primary or secondary lower alkyl (e.g., an alkyl containing 1 to 7 carbon atoms), haloalkyl, aminoalkyl, alkenylalkyl, alkynylalkyl, aryl (e.g., phenyl), hydrocarbonoxy, and halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are end groups resulting from backward dimer incorporation during the manufacture of the poly(arylene ether), e.g., tetramethyl diphenylquinone (TMDQ), when 2,6-xylenol is used as a monomer.

The poly(arylene ether) may be in the form of a homopolymer; a copolymer; a graft copolymer; an ionomer; a block copolymer, for example comprising arylene ether units and blocks derived from alkenyl aromatic compounds; as well as combinations comprising at least one of the foregoing. Poly(arylene ether) includes polyphenylene ether comprising 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol, 2,3,6-trimethylphenol or a combination of 2,6-xylenol and 2,3,6-trimethylphenol. Catalyst systems are generally employed for such coupling; they can contain heavy metal compound(s) such as a copper, manganese, or cobalt compound, usually in combination with various other materials such as a secondary amine, tertiary amine, halide or combination of two or more of the foregoing.

The poly(arylene ether) can have a number average molecular weight of 3,000 to 40,000 grams per mole (g/mol), a weight average molecular weight of 5,000 to 80,000 g/mol or a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) can have an initial intrinsic viscosity of 0.10 to 0.60 deciliters per gram (dl/g), or, more specifically, 0.29 to 0.48 dl/g, as measured in chloroform at 25° C. Initial intrinsic viscosity is defined as the intrinsic viscosity of the poly(arylene ether) prior to melt mixing with the other components of the composition and final intrinsic viscosity is defined as the intrinsic viscosity of the poly(arylene ether) after melt mixing with the other components of the composition. As understood by one of ordinary skill in the art the intrinsic viscosity of the poly(arylene ether) may be up to 30% higher after melt mixing. The percentage of increase can be calculated by (final intrinsic viscosity−initial intrinsic viscosity)/initial intrinsic viscosity. Determining an exact ratio, when two initial intrinsic viscosities are used, will depend somewhat on the exact intrinsic viscosities of the poly(arylene ether) used arid the ultimate physical properties that are desired.

In one embodiment the poly(arylene ether) has a glass transition temperature (Tg) as determined by differential scanning calorimetry (DSC at 20° C./minute ramp) in a nitrogen atmosphere, of 160° C. to 280° C. Within this range the Tg may be greater than or equal to 180° C., or, more specifically, greater than or equal to 200° C. Also within this range the Tg may be less than or equal to 240° C., or, more specifically, less than or equal to 230° C.

The composition comprises poly(arylene ether) in an amount such that the poly(arylene ether) is present as a dispersed or co-continuous phase. Poly(arylene ether) can be present in an amount of 15 to 65 weight percent. Within this range, the poly(arylene ether) may be present in an amount greater than or equal to 20 weight percent, or, more specifically, in an amount greater than or equal to 25 weight percent, or, even more specifically, in an amount greater than or equal to 30 weight percent. Also within this range the poly(arylene ether) may be present in an amount less than or equal to 60 weight percent, or, more specifically, less than or equal to 55 weight percent, or, even more specifically, less than or equal to 50 weight percent. Weight percent is based on the total weight of the thermoplastic composition.

Polyamide resins, also known as nylons, are characterized by the presence of an amide group (—C(O)NH—), and are described in U.S. Pat. No. 4,970,272. Exemplary polyamide resins include, but are not limited to, nylon-6; nylon-6,6; nylon-4; nylon-4,6; nylon-12; nylon-6,10; nylon-6,9; nylon-6,12; amorphous polyamides; polyphthalamides; nylon-6/6T and nylon-6,6/6T with triamine contents below 0.5 weight percent; nylon-9T and combinations comprising one or more of the foregoing polyamides. The composition may comprise two or more polyamides, for example the polyamide may comprises nylon-6 and nylon-6,6. In one embodiment the polyamide resin or combination of polyamide resins has a melting point (Tm) greater than or equal to 171° C. When the polyamide comprises a super tough polyamide, i.e. a rubber-toughed polyamide, the composition may or may not contain a separate impact modifier.

Polyamide resins may be obtained by a number of well known processes such as those described in U.S. Pat. Nos. 2,071,250; 2,071,251; 2,130,523; 2,130,948; 2,241,322; 2,312,966; 2,512,606; and 6,887,930. Polyamide resins are commercially available from a wide variety of sources.

Polyamide resins having an intrinsic viscosity of up to 400 milliliters per gram (ml/g) can be used, or, more specifically, having a viscosity of 90 to 350 ml/g, or, even more specifically, having a viscosity of 110 to 240 ml/g, as measured in a 0.5 wt % solution in 96 wt % sulfuric acid in accordance with ISO 307.

The polyamide may have a relative viscosity of up to 6, or, more specifically, a relative viscosity of 1.89 to 5.43, or, even more specifically, a relative viscosity of 2.16 to 3.93. Relative viscosity is determined according to DIN 53727 in a 1 wt % solution in 96 wt % sulfuric acid.

In one embodiment, the polyamide resin comprises a polyamide having an amine end group concentration greater than or equal to 35 microequivalents amine end group per gram of polyamide (μeq/g) as determined by titration with HCl. Within this range, the amine end group concentration may be greater than or equal to 40 μeq/g, or, more specifically, greater than or equal to 45 μeq/g. The maximum amount of amine end groups is typically determined by the polymerization conditions and molecular weight of the polyamide. Amine end group content may be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution and the weight of the polyamide sample.

The composition comprises polyamide in an amount sufficient to form a continuous phase or co-continuous phase of the composition. The amount of polyamide can be 30 to 85 weight percent. Within this range, the polyamide may be present in an amount greater than or equal to 33 weight percent, or, more specifically, in an amount greater than or equal to 38 weight percent, or, even more specifically, in an amount greater than or equal to 40 weight percent. Also within this range, the polyamide may be present in an amount less than or equal to 60 weight percent, or, more specifically, less than or equal to 55 weight percent, or, even more specifically, less than or equal to 50 weight percent. Weight percent is based on the total weight of composition.

When used herein, the expression “compatibilizing agent” refers to polyfunctional compounds which interact with the poly(arylene ether), the polyamide resin, or both. This interaction may be chemical (e.g., grafting) and/or physical (e.g., affecting the surface characteristics of the dispersed phases). In either instance the resulting compatibilized poly(arylene ether)/polyamide composition appears to exhibit improved compatibility, particularly as evidenced by enhanced impact strength, mold knit line strength and/or elongation. As used herein, the expression “compatibilized poly(arylene ether)/polyamide blend” refers to those compositions which have been physically and/or chemically compatibilized with an agent as discussed above, as well as those compositions which are physically compatible without such agents, as taught in U.S. Pat. No. 3,379,792.

As understood by one of ordinary skill in the art, poly(arylene ether) and polyamide, when combined, form an immiscible blend. Immiscible blends have either a continuous phase and a dispersed phase or two co-continuous phases. When a continuous phase and a dispersed phase are present the size of the particles of the dispersed phase can be determined using electron microscopy. In a compatibilized poly(arylene ether)/polyamide blend the average diameter of the dispersed phase particles (poly(arylene ether)) is decreased compared to non-compatibilized poly(arylene ether)/polyamide blends. For example, compatibilized poly(arylene ether)/polyamide blends have an average poly(arylene ether) particle diameter less than or equal to 10 micrometers. In some embodiments the average particle diameter is greater than or equal to 0.05 micrometers. The average particle diameter in a pelletized blend may be smaller than in a molded article but in either case the average particle diameter is less than or equal to 10 micrometers. Determination of average particle diameter is known in the art and is taught, for example, in U.S. Pat. Nos. 4,772,664 and 4,863,996.

Examples of the various compatibilizing agents that may be employed include: liquid diene polymers, epoxy compounds, oxidized polyolefin wax, quinones, organosilane compounds, polyfunctional compounds, functionalized poly(arylene ether) and combinations comprising at least one of the foregoing. Compatibilizing agents are further described in U.S. Pat. Nos. 5,132,365 and 6,593,411 as well as U.S. Patent Application No. 2003/0166762.

In one embodiment, the compatibilizing agent comprises a polyfunctional compound. Polyfunctional compounds which may be employed as a compatibilizing agent are of three types. The first type of polyfunctional compounds are those having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated dicarboxylic acids (e.g., acrylic acid, butenoic acid, methacrylic acid, t-ethylacrylic acid, pentenoic acid); decenoic acids, undecenoic acids, dodecenoic acids, linoleic acid, etc.); esters, acid amides or anhydrides of the foregoing unsaturated carboxylic acids; unsaturated alcohols (e.g. alkyl alcohol, crotyl alcohol, methyl vinyl carbinol, 4-pentene-1-ol, 1,4-hexadiene-3-ol, 3-butene-1,4-diol, 2,5-dimethyl-3-hexene-2,5-diol and alcohols of the formula CₙH₂ₙ₋₅OH, CₙH₂ₙ₋₇OH and CHₙH₂ₙ₋₉OH, wherein n is 5 to 30; unsaturated amines resulting from replacing from replacing the —OH group(s) of the above unsaturated alcohols with NH₂ groups; functionalized diene polymers and copolymers; and combinations comprising one or more of the foregoing. In one embodiment, the compatibilizing agent comprises maleic anhydride, fumaric acid, or a combination of maleic anhydride and fumaric acid.

The second type of polyfunctional compatibilizing agents are characterized as having both (a) a group represented by the formula (OR) wherein R is hydrogen or an alkyl, aryl, acyl, or carbonyl dioxy group and (b) at least two groups each of which may be the same or different selected from carboxylic acid, acid halide, anhydride, acid halide anhydride. ester, orthoester, amide, imido, amino, and various salts thereof. Exemplary of this group of compatibilizers are the aliphatic polycarboxylic acids, acid esters and acid amides represented by the formula
(R^{I}O)ₘR^{V}(COOR^{II})ₙ(CONR^{III}R^{IV})ₛ
wherein R^{V} is a linear or branched chain, saturated aliphatic hydrocarbon having 2 to 20, or, more specifically, 2 to 10, carbon atoms; R^{I} is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polyfunctional compatibilizing agents of the second type also include, for example, citric acid, malic acid, agaricic acid; including the various commercial forms thereof, such as for example, the anhydrous and hydrated acids; and combinations comprising one or more of the foregoing. In one embodiment, the compatibilizing agent comprises citric acid. Illustrative of esters useful herein include, for example, acetyl citrate, mono- and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; N-dodecyl malic acid, and combinations comprising one or more of the foregoing amides. Derivates include the salts thereof, including the salts with amines and the alkali and alkaline metal salts. Exemplary of suitable salts include calcium malate, calcium citrate, potassium malate, and potassium citrate.

The third type of polyfunctional compatibilizing agents are characterized as having in the molecule both (a) an acid halide group and (b) at least one carboxylic acid, anhydride, ester, epoxy, orthoester, or amide group. Examples of compatibilizers within this group include trimellitic anhydride acid chloride, chloroformyl succinic anhydride, chloro formyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In one embodiment, the compatibilizing agent comprises trimellitic anhydride acid chloride.

The thermoplastic composition is produced by melt blending the components. The foregoing compatibilizing agents may be added directly to the melt blend or pre-reacted with either or both of the poly(arylene ether) and polyamide, as well as with other resinous materials employed in the preparation of the composition. With many of the foregoing compatibilizing agents, particularly the polyfunctional compounds, even greater improvement in compatibility is found when at least a portion of the compatibilizing agent is pre-reacted, either in the melt or in a solution of a suitable solvent, with all or a part of the poly(arylene ether). It is believed that such pre-reacting may cause the compatibilizing agent to react with the polymer and, consequently, functionalize all or part of the poly(arylene ether). For example, the poly(arylene ether) may be pre-reacted with maleic anhydride to form an anhydride functionalized polyphenylene ether which when melt blended with polyamide and optionally non-functionalized poly(arylene ether) results in a compatibilized poly(arylene ether)/polyamide blend.

Where the compatibilizing agent is employed in the preparation of the compositions, the amount used will be dependent upon the specific compatibilizing agent chosen and the specific polymeric system to which it is added as well as the desired properties of the resultant composition.

The first impact modifier comprises one or more moieties selected from the group consisting of carboxylic acid, anhydride, epoxy, oxazoline, and ester. When the impact modifier comprises a carboxylic acid moiety the carboxylic acid moiety may be neutralized with an ion, such as zinc or sodium. It may be an alkylene-alkyl (meth)acrylate copolymer and the alkylene groups may have 2 to 6 carbon atoms and the alkyl group of the alkyl (meth)acrylate may have 1 to 8 carbon atoms. This type of polymer can be prepared by copolymerizing an olefin, for example, ethylene, propylene, or a combination of ethylene and propylene, with various (meth)acrylate monomers and/or various maleic-based monomers. The term (meth)acrylate refers to both the acrylate as well as the corresponding methacrylate analogue. Included within the term (meth)acrylate monomers are alkyl (meth)acrylate monomers as well as various (meth)acrylate monomers containing at least one of the aforementioned reactive moieties.

In one embodiment, the first impact modifier is a copolymer is derived from ethylene, propylene, or mixtures of ethylene and propylene, as the alkylene component; butyl acrylate, hexyl acrylate, propyl acrylate, a corresponding alkyl (methyl)acrylates or a combination of the foregoing acrylates, for the alkyl (meth)acrylate monomer component, with acrylic acid, maleic anhydride, glycidyl methacrylate or a combination thereof as monomers providing an additional moieties (i.e., carboxylic acid, anhydride, epoxy). In one embodiment the amount of units derived from acrylic acid, maleic anhydride, glycidyl methacrylate or combination thereof may be 2 to 10 weight percent based on the total weight of the copolymer.

In one embodiment, the first impact modifier is substantially free of aromatic groups. For example, the first impact modifier may be substantially free of aryl alkylene units derived from styrene. The term “substantially free”, when used in conjunction with the first impact modifier is defined as containing less than or equal to 5 weight percent, or, more specifically, less than or equal to 4 weight percent, or, even more specifically, less than or equal to 3 weight percent, of aromatic groups, such as aryl alkylene units, based on the total weight of the first impact modifier.

Exemplary first impact modifiers are commercially available under a variety of tradenames including ELVALOY, SURLYN, and FUSABOND, all of which are available from DuPont.

The amount of the first impact modifier is sufficient to increase the Notched Izod strength of the composition when compared to a composition employing only a second impact modifier as described herein. The amount of the first impact modifier can be 1 to 5 weight percent based on the total weight of the composition. Within this range, the amount of the first impact modifier may be greater than or equal to 2 weight percent. Also within this range the amount of the first impact modifier may be less than or equal to 4 weight percent.

The second impact modifier can be a block copolymer, for example, A-B diblock copolymers and A-B-A triblock copolymers having of one or two aryl alkylene blocks A, which are typically polystyrene blocks, and a rubber block, B, which is typically a block derived from isoprene, butadiene or isoprene and butadiene. The block derived from butadiene, isoprene or butadiene and isoprene may be partially or completely hydrogenated. Mixtures of these diblock and triblock copolymers may also be used as well as mixtures of non-hydrogenated copolymers, partially hydrogenated copolymers, fully hydrogenated copolymers and combinations of two or more of the foregoing. The second impact modifier is essentially free of carboxylic acid, anhydride, epoxy, oxazoline, and ester moieties. Essentially free of carboxylic acid, anhydride, epoxy, oxazoline, and ester moieties is defined as comprising less than 5 weight percent, or, more specifically, less than 3 weight percent, or, even more specifically, less than 1 weight percent of these moieties based on the total weight of the second impact modifier.

A-B and A-B-A copolymers include, but are not limited to, polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-polyisoprene-polystyrene and poly(alpha-methylstyrene)-polybutadiene-poly(alpha-methylstyrene), polystyrene-poly(ethylene-propylene-styrene)-polystyrene, and the like. Mixtures of the aforementioned block copolymers are also useful. Such A-B and A-B-A block copolymers are available commercially from a number of sources, including Phillips Petroleum under the trademark SOLPRENE, KRATON Polymers, under the trademark KRATON, Dexco under the trademark VECTOR, Asahi Kasai under the trademark TUFTEC, Total Petrochemicals under the trademarks FINAPRENE and FINACLEAR and Kuraray under the trademark SEPTON.

In one embodiment, the second impact modifier comprises polystyrene-poly(ethylene-butylene)-polystyrene, polystyrene-poly(ethylene-propylene), or a combination of the foregoing second impact modifiers.

The composition may comprise the second impact modifier in an amount of 1 to 15 weight percent. Within this range, the second impact modifier may be present in an amount greater than or equal to 1.5 weight percent, or, more specifically, in an amount greater than or equal to 2 weight percent, or, even more specifically, in an amount greater than or equal to 4 weight percent. Also within this range, the impact modifier may be present in an amount less than or equal to 13 weight percent, or, more specifically, less than or equal to 12 weight percent, or, even more specifically, less than or equal to 10 weight percent. Weight percent is based on the total weight of the thermoplastic composition.

In one embodiment the combination of the first and second impact modifiers is present in an amount that results in compositions that exhibit a puncture deflection greater than or equal to 8 millimeters, or, more specifically, greater than or equal to 10 millimeters, when a sample is impacted at 23° C. in accordance with ISO 6603-2. In one embodiment, the amount of the combined impact modifiers is that which will result in compatibilized poly(arylene ether)-polyamide compositions having puncture energy greater than or equal to 15 Joules, or, more specifically, greater than or equal to 18 Joules, or, even more specifically, greater than or equal to 20 Joules, when a sample is impacted at 23° C. in accordance with ISO 6603-2. In one embodiment, the compositions has a puncture energy greater than or equal to 18 Joules with a puncture deflection greater than or equal to 10 millimeters, or, more specifically, have a puncture energy greater than or equal to 20 Joules with a puncture deflection greater than or equal to 11 millimeters, or, even more specifically, have a puncture energy greater than or equal to 24 Joules with a puncture deflection greater than or equal to 12 millimeters, when an unpainted plaque is impacted at 23° C. by a falling dart in accordance with ISO 6603-2.

As disclosed herein ISO 6603-2 is performed using a striker having a tip with a 20 millimeter diameter. The striker speed is 4.4 meters per second. The specimens are unpainted, have a diameter of 60 millimeters and a thickness of 2 millimeters, and are clamped using a support having a diameter of 40 millimeters. Prior to testing the specimens are conditioned at 23° C. and 50% relative humidity for 48 hours before testing. Unless otherwise specified all values given are the mean of the five samples.

In one embodiment the weight ratio of the first impact modifier to the second impact modifier is 0.15 to 0.67, or more specifically, 0.25 to 0.50, and the combined weight of impact modifier is 10 to 20 weight percent, or more specifically, 12 to 17 weight percent, based on the combined weight of poly(arylene ether), polyamide and impact modifiers.

The composition further comprises an electrically conductive carbon black. Electrically conductive carbon blacks are commercially available and are sold under a variety of trade names, including but not limited to S.C.F. (Super Conductive Furnace), E.C.F. (Electric Conductive Furnace), KETJENBLACK EC (available from Akzo Co., Ltd.) or acetylene black. In some embodiments the electrically conductive carbon black has an average particle size less than or equal to 200 nanometers (nm), or, more specifically, less than or equal to 100 nm, or, even more specifically, less than or equal to 50 nm. The electrically conductive carbon blacks may also have surface areas greater than 200 square meter per gram (m²/g), or, more specifically, greater than 400 m²/g, or, even more specifically, greater than 900 m²/g as determined by BET analysis. The electrically conductive carbon black may have a pore volume greater than or equal to 40 cubic centimeters per hundred grams (cm³/100 g), or, more specifically, greater than or equal to 100 cm³/100 g, or, even more specifically, greater than or equal to 150 cm³/100 g, as determined by dibutyl phthalate absorption.

The composition comprises a sufficient amount of electrically conductive filler to achieve a specific volume resistivity less than or equal to 10⁶ ohm-cm. For example, the composition may comprise electrically conductive carbon black in an amount of 0.1 to 5.0 weight percent. Within this range, the electrically conductive carbon black may be present in an amount greater than or equal to 0.8 weight percent, or, more specifically, in an amount greater than or equal to 1.0 weight percent, or, even more specifically, in an amount greater than or equal to 1.2 weight percent. Also within this range, the electrically conductive carbon black may be present in an amount less than or equal to 4.0 weight percent, or, more specifically, less than or equal to 3.0 weight percent, or, even more specifically, less than or equal to 2.0 weight percent. Weight percent is based on the total weight of the thermoplastic composition.

As mentioned above, the composition comprises a fibrous filler selected from the group consisting of carbon fibers, carbon nanotubes, glass fibers and combinations thereof.

Carbon nanotubes that can be used include single wall carbon nanotubes (SWNTs), multiwall carbon nanotubes (MWNTs), vapor grown carbon fibers (VGCF) and combinations comprising two or more of the foregoing.

Single wall carbon nanotubes (SWNTs) may be produced by laser-evaporation of graphite, carbon arc synthesis or a high-pressure carbon monoxide conversion process (HIPCO) process. These SWNTs generally have a single wall comprising a graphene sheet with outer diameters of 0.7 to 2.4 nanometers (nm). The SWNTs may comprise a mixture of metallic SWNTs and semi-conducting SWNTs. Metallic SWNTs are those that display electrical characteristics similar to metals, while the semi-conducting SWNTs are those that are electrically semi-conducting. In some embodiments it is desirable to have the composition comprise as large a fraction of metallic SWNTs as possible. SWNTs may have aspect ratios of greater than or equal to 5, or, more specifically, greater than or equal to 100, or, even more specifically, greater than or equal to 1000. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

In one embodiment the SWNTs comprise metallic nanotubes in an amount of greater than or equal to 1 wt %, or, more specifically, greater than or equal to 20 wt %, or, more specifically, greater than or equal to 30 wt %, or, even more specifically greater than or equal to 50 wt %, or, even more specifically, greater than or equal to 99.9 wt % of the total weight of the SWNTs.

In one embodiment the SWNTs comprise semi-conducting nanotubes in an amount of greater than or equal to 1 wt %, or, more specifically, greater than or equal to 20 wt %, or, more specifically, greater than or equal to 30 wt %, or, even more specifically, greater than or equal to 50 wt %, or, even more specifically, greater than or equal to 99.9 wt % of the total weight of the SWNTs.

MWNTs may be produced by processes such as laser ablation and carbon arc synthesis. MWNTs have at least two graphene layers bound around an inner hollow core. Hemispherical caps generally close both ends of the MWNTs, but it is also possible to use MWNTs having only one hemispherical cap or MWNTs which are devoid of both caps. MWNTs generally have diameters of 2 to 50 nm. Within this range, the MWNTs may have an average diameter less than or equal to 40, or, more specifically, less than or equal to 30, or, even more specifically less than or equal to 20 nm. MWNTs may have an average aspect ratio greater than or equal to 5, or, more specifically, greater than or equal to 100, or, even more specifically greater than or equal to 1000.

In one embodiment, the MWNT comprises vapor grown carbon fibers (VGCF). VGCF are generally manufactured in a chemical vapor deposition process. VGCF having “tree-ring” or “fishbone” structures may be grown from hydrocarbons in the vapor phase, in the presence of particulate metal catalysts at moderate temperatures, i.e., 800 to 1500° C. In the “tree-ring” structure a multiplicity of substantially graphitic sheets are coaxially arranged around the core. In the “fishbone” structure, the fibers are characterized by graphite layers extending from the axis of the hollow core.

VGCF having diameters of 3.5 to 2000 nanometers (nm) and aspect ratios greater than or equal to 5 may be used. VGCF may have diameters of 3.5 to 500 nm, more specifically 3.5 to 100 nm, or, even more specifically 3.5 to 50 nm. VGCF may have an average aspect ratios greater than or equal to 100, or, more specifically, greater than or equal to 1000.

Various types of conductive carbon fibers may also be used in the composition. Carbon fibers are generally classified according to their diameter, morphology, and degree of graphitization (morphology and degree of graphitization being interrelated). These characteristics are presently determined by the method used to synthesize the carbon fiber. For example, carbon fibers having diameters down to 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch.

The carbon fibers generally have a diameter of greater than or equal to 1,000 nanometers (1 micrometer) to 30 micrometers. Within this range fibers having a diameter greater than or equal to 2, or, more specifically, greater than or equal to 3, or, more specifically greater than or equal to 4 micrometers may be used. Also within this range fibers having a diameter less than or equal to 25, or, more specifically, less than or equal to 15, or, even more specifically less than or equal to 11 micrometers may be used.

In one embodiment, the fibrous filler comprises glass fiber in combination with carbon fiber, carbon nanotubes or carbon fibers and carbon nanotubes and the composition has a CTE less than or equal to 6.5° C.⁻¹ and a NI value greater than or equal to 9 kJ/m². The CTE may also be less than or equal to 6.0° C.⁻¹, or, even more specifically, less than or equal to 5.5° C.⁻¹. The NI value may be greater than or equal to 9.2 kJ/m², or, more specifically, greater than or equal to 9.8 kJ/m² when determined at 23° C.

Suitable glass fibers include glass fibers having a diameter of 2 to 10 micrometers and an average length, prior to melt mixing with the other components, of 4 to 10 millimeters.

The fibrous filler may be present in an amount of 2 to 30 weight percent, based on the total weight of the composition. Within this range the amount of fibrous filler may be greater than or equal to 3 weight percent, or, more specifically, greater than or equal to 4 weight percent, or, even more specifically, greater than or equal to 5 weight percent. Also within this range, the fibrous filler may be present in an amount less than or equal to 25 weight percent, or, more specifically, less than or equal to 20 weight percent, or, even more specifically, less than or equal to 15 weight percent. Weight percent is based on the total weight of the thermoplastic composition.

In one embodiment the fibrous filler in the composition, after melt blending, has an average length of 40 to 150 micrometers, or more specifically, 50 to 140 micrometers, or even more specifically, 60 to 130 micrometers. As understood by one of skill in the art the average length of the fibers in the composition will be less than that of the fibers when added to form the composition due to breakage (attrition) during processing.

The composition may further comprise particulate filler. Particulate filler, as used herein, described fillers having an aspect ratio (length/width) less than or equal to 1. Exemplary particulate fillers include glass beads, talc, mica and the like. The particulate filler may comprise combinations of different particulate fillers. In one embodiment the particulate filler comprises talc. When present the particulate filler may be present in an amount of 5 to 30 weight percent based on the total weight of the composition. Within this range the amount of particulate filler may be greater than or equal to 7 weight percent, or more specifically greater than or equal to 10 weight percent. Also within this range the amount of particulate filler may be less than or equal to 25 weight percent or more specifically, less than or equal to 20 weight percent or, even more specifically, less than or equal to 15 weight percent.

In some embodiments it is desirable to incorporate a sufficient amount of electrically conductive filler to achieve a specific volume resistivity that is sufficient to permit the composition or article made of the composition to dissipate electrostatic charges or to be thermally dissipative.

The composition may also include effective amounts of at least one additive selected from the group consisting of antioxidants, flame retardants, drip retardants, dyes, pigments, colorants, stabilizers, antistatic agents, plasticizers, lubricants, and mixtures thereof. These additives are known in the art, as are their effective levels and methods of incorporation. Effective amounts of the additives vary widely, but they are usually present in an amount up to 50% or more by weight based on the weight of the entire composition. In one embodiment additives include hindered phenols, thio compounds and amides derived from various fatty acids. Amounts of these additives generally ranges up to 2% total combined weight based on the total weight of the composition.

In some embodiments the composition consists essentially of a compatibilized poly(arylene ether)/polyamide blend, electrically conductive carbon black, fibrous filler selected from the group consisting of carbon fibers, carbon nanotubes, glass fibers and combinations of two or more of the preceding fibrous fillers, a first impact modifier comprising at least two moieties selected from the group consisting of carboxylic acid, anhydride, epoxy, oxazoline and ester, and a second impact modifier comprising aryl alkylene units wherein the first impact modifier is essentially free of aryl alkylene units. As used herein with reference to the composition the term “consists essentially of” permits the inclusion of conventional additives and can trace amounts of contaminants and side products.

The composition can be prepared by melt blending or a combination of dry blending and melt blending. Melt blending can be performed in single or twin screw type extruders or similar mixing devices which can apply a shear to the components.

All of the ingredients may be added initially to the processing system. In some embodiments, the poly(arylene ether) may be melt blended with the compatibilizing agent to form a first mixture and optionally pelletized. Additionally other ingredients such as the second impact modifier, additives, or a combination thereof may be melt blended with the compatibilizing agent and poly(arylene ether) to for a first mixture and optionally pelletized. The first mixture is melt blended with the polyamide and first impact modifier.

When using an extruder, all or part of the polyamide may be fed through a port downstream. While separate extruders may be used in the processing, preparations in a single extruder having multiple feed ports along its length to accommodate the addition of the various components simplifies the process. It is often advantageous to apply a vacuum to the melt through one or more vent ports in the extruder to remove volatile impurities in the composition.

The electrically conductive carbon black may be added by itself, with other ingredients (optionally as a dry blend) or as part of a masterbatch. In one embodiment, the electrically conductive carbon black is part of a masterbatch comprising polyamide. The electrically conductive carbon black (independently or as a masterbatch) may be added with the poly(arylene ether), with the polyamide (the second portion when two portions are employed), or after the addition of the polyamide (the second portion when two portions are employed).

The fibrous filler may be added by itself, with other ingredients (optionally as a dry blend) or as part of a masterbatch. In one embodiment all or part of the fibrous filler is part of a masterbatch comprising polyamide and optionally the first impact modifier. The fibrous filler (independently or as a masterbatch) may be added with the poly (arylene ether), with the polyamide (the second portion when two portions are employed), or after the addition of the polyamide (the second portion when two portions are employed).

As used herein the term “masterbatch” describes a melt blend of one or more thermoplastics and one or more additives wherein the additive, such as electrically conductive carbon black, is present in the masterbatch in a higher concentration than it is found in the final thermoplastic composition. For example, a masterbatch may comprise one or more additives and polyamide, one or more impact modifiers, or a combination of polyamide and one or more impact modifiers.

In one embodiment, a method of making a thermoplastic composition comprises melt blending a poly(arylene ether), a compatibilizer and a second impact modifier to form a first mixture. The second impact modifier comprises aryl alkylene units. The first mixture is melt blended with a polyamide, a first masterbatch, and a second masterbatch. The first masterbatch comprises polyamide and electrically conductive carbon black. The second masterbatch comprises polyamide, a first impact modifier and fibrous filler. The first impact modifier comprises at least two moieties selected from the group consisting of carboxylic acid, anhydride, epoxy, oxaziline and ester and is essentially free of aryl alkylene units. The fibrous filler is selected from the group consisting of carbon fibers, glass fibers, carbon nanotubes and combinations of two or more of the preceding fibrous fillers.

In one embodiment a method of making a thermoplastic composition comprises melt blending a poly(arylene ether), a compatibilizer and a second impact modifier comprising aryl alkylene units to form a first mixture. The first mixture is melt blended with a polyamide and a masterbatch to form a second mixture. The masterbatch comprises polyamide, a first impact modifier essentially free of aryl alkylene units and comprising at least two moieties selected from the group consisting of carboxylic acid, anhydride, epoxy, oxazoline and ester, and a fibrous filler selected from the group consisting of carbon fillers, carbon nanotubes, glass fibers, and combinations of two or more of the foregoing fibrous fillers. The second mixture is melt blended with electrically conductive carbon black.

In one embodiment the composition comprises a reaction product of poly(arylene ether); polyamide; electrically conductive carbon black; compatibilizing agent; fibrous filler and impact modifiers. As used herein a reaction product is defined as a product resulting from the reaction of two or more of the foregoing components under the conditions employed to form the composition or during further processing of the components, for example during melt mixing or molding.

In some embodiments melt mixing is performed using an extruder and the composition exits the extruder in a strand or multiple strands. The shape of the strand is dependent upon the shape of the die used and has no particular limitation. The strand diameter and the pellet length are typically chosen to prevent or reduce the production of fines (particles that have a volume less than or equal to 50% of the pellet) and for maximum efficiency in subsequent processing such as profile extrusion, An exemplary pellet length is 1 to 5 millimeters and an exemplary pellet diameter is 1 to 5 millimeters.

The pellets may exhibit hygroscopic properties. Once water is absorbed it may be difficult to remove. It is advantageous to protect the composition from ambient moisture. In one embodiment the pellets, once cooled to a temperature of 50° C. to 110° C., are packaged in a container comprising a mono-layer of polypropylene resin free of a metal layer wherein the container has a wall thickness of 0.25 millimeters to 0.60 millimeters. The pellets, once cooled to 50 to 110° C. can also be packaged in foiled lined containers such as foil lined boxes and foil lined bags or other types of containers having a moisture barrier.

The composition may be converted to articles using low shear thermoplastic processes such as film and sheet extrusion, profile extrusion, extrusion molding, compression molding and blow molding. Film and sheet extrusion processes may include and are not limited to melt casting, blown film extrusion and calendaring. Co-extrusion and lamination processes may be employed to form composite multi-layer films or sheets. Before the pelletized composition is formed into an article the pelletized composition may be dried by keeping the pelletized composition at an elevated temperature although extended drying may affect the performance of the composition. Water, above 0.01-0.1%, or, more specifically, 0.02-0.07% moisture by weight, can hinder the use of the composition in some applications.

Single or multiple layers of coatings may further be applied to the single or multi-layer substrates to impart additional properties such as scratch resistance, ultra violet light resistance, aesthetic appeal, etc. Coatings may be applied through standard application techniques such as rolling, spraying, dipping, brushing, or flow-coating.

In one embodiment a vehicular body part comprises a thermoplastic composition wherein the thermoplastic composition comprises:

a compatibilized poly(arylene ether)/polyamide blend,

electrically conductive carbon black,

fibrous filler selected from the group consisting of carbon fibers, carbon nanotubes, glass fibers and combinations of two or more of the preceding fibrous fillers,

a first impact modifier comprising at least two moieties selected from the group consisting of carboxylic acid, anhydride, epoxy, oxazoline and ester, and

a second impact modifier comprising aryl alkylene units wherein the first impact modifier is essentially free of aryl alkylene units. The vehicular body part may be painted or unpainted. The vehicular body part may be, for example, a fender, a quarter panel, a door panel, bumper or hood. Vehicular refers to motorized transport having two or more wheels such as motorcycles, motor scooters, cars, trucks, golf carts, and the like.

The vehicular body part has an average linear coefficient of thermal expansion less than or equal to 7.5×10⁻⁵° C.⁻¹. In some embodiments the vehicular body part has a maximum linear coefficient of thermal expansion less than 8.5×10⁻⁵° C.⁻¹. The maximum linear coefficient of thermal expansion may be greater than or equal to 4.0×10⁻⁵° C.⁻¹.

The average linear coefficient of thermal expansion may be determined by cutting 4 to 6 samples from the vehicular body part. The distance between the samples, at their closest point, is greater than or equal to five percent of the circumference of the vehicular body part. The samples have dimensions of 10 mm×5 mm plus or minus 1 millimeter. The thickness of the samples is determined by the thickness of the vehicular body part and, in some embodiments, may be 25 mm to 4 mm. The samples are tested for the coefficient of thermal expansion as described above with regard to the mean coefficient of thermal expansion with the exception that the samples are tested along both the length and the width of the samples. The average linear coefficient of thermal expansion is the mean of the coefficients of thermal expansion in the length direction of all samples and the coefficients of thermal expansion in the width direction of all samples.

The maximum linear coefficient of thermal expansion is the largest linear coefficient of thermal expansion either in the width or length direction of the samples used to determine the average linear coefficient of thermal expansion.

The following non-limiting examples further illustrate the various embodiments described herein.

### EXAMPLES

The examples were produced using the materials listed in Table 1 unless otherwise specified.

TABLE 1

| Material | Description |
|---|---|
| PPE | Poly(2,6-dimethylphenylene ether) was |
| | obtained from GE Plastics and had a |
| | weight average molecular weight (Mw) |
| | of 44,000 and an intrinsic viscosity of 0.4 |
| | deciliters per gram (dl/g) measured in |
| | chloroform at 23° C. |
| SEBS | Polystyrene-poly(ethylene-butylene)- |
| | polystyrene commercially available from |
| | KRATON Polymers under the tradename |
| | KRATON G1651E |
| SEP | Polystyrene-poly(ethylene-propylene) |
| | commercially available from KRATON |
| | Polymers under the tradename KRATON |
| | G1701E. |
| CA | Anhydrous citric acid available from SD |
| | Fine Chem Ltd. |
| IM | Terpolymer of ethylene, butylacrylate, |
| | and glycidyl methacrylate commercially |
| | available from DuPont under the |
| | tradename ELVALOY PTW |
| CF | Carbon fiber commercially available |
| | from TohoTenax America, Inc. under the |
| | tradename TENAX F201. |
| GF | Amino silane coated glass fiber |
| | commercially available from NEG. |
| Polyamide 66 | Nylon-6,6 having weight average |
| | molecular weight (Mw) of 69,000 and a |
| | viscosity number ISO 307 (Vz) of 126 |
| | ml/g available from Rhodia under the |
| | grade name of 24 FE 1. |
| Polyamide 6 | Nylon-6 available as TECHNYL |
| | ASN27/32-35 1c from Rhodia |
| CCB | Conductive carbon black commercially |
| | available under the tradename |
| | KETJENBLACK EC 600JD from Akzo |
| | Nobel |

Some examples were tested for specific volume resistivity (SVR). The compositions were injection molded into ISO tensile bars. The bars were scored at a location 25 millimeters from the center of the bar on each side and then submerged in liquid nitrogen for approximately 5 minutes. As soon as the bars were removed from the liquid nitrogen they were snapped at the score marks for a brittle break. The ends were painted with electrically conductive silver paint and dried. Resistance was measured by placing the probes of a handheld multimeter on each painted end of the bar. The multimeter used was a Mastech M92A multimeter. The resistivity was calculated as the resistance (in Ohms)×bar width (in centimeters (cm))×bar depth (cm) divided by the bar length (cm). Results are reported in kilo Ohms centimeter.

Samples were tested for mean coefficient of thermal expansion (CTE) in the flow directions according to ISO 11359-2 after annealing the samples for 60 minutes at 180° C. unless otherwise specified. The temperature range used to obtain the test data was 23 to 60° C. unless otherwise specified. Further information on testing and testing methods is supplied in Table 2.

TABLE 2

| Test | | | |
|---|---|---|---|
| Method | Material Property | Units of data | Machine/Instrument |
| ISO 527 | Nominal tensile | % | Instron 5566 |
| | strain at break at | | |
| | 50 millimeters | | |
| | per minute | | |
| ISO | Notched Izod | kilojoules per square | CEAST Izod Tester |
| 180/1A | impact strength | meter (kJ/m²) | |
| | (2 millimeter | | |
| | notch) | | |
| ISO | Puncture energy | Joule (J) | Zwick-Roell 1852 |
| 6603-2 | | | servohydraulic UTM |
| ISO | Puncture | Millimeters (mm) | Zwick-Roell 1852 |
| 6603-2 | deflection | | servohydraulic UTM |
| ISO | CTE | ×10⁻⁵° C.⁻¹ | TA-TMA2940 |
| 11359-2 | | | |
| ISO 306 | Vicat softening | ° C. | CEAST VST |
| | temperature | | |
| | (VST) (B/120) | | |

### Comparative Examples 1-14

Examples were made by melt blending 27.1 weight % (wt %) PPE, 6.4 wt % SEP, 5.6 wt % SEBS, 0.7 wt % citric acid, 48wt % PA, 10 wt % filler, 1.8 wt % CCB and a conventional additive package wherein the amounts are with respect to the total weight of the composition. The fillers were varied as shown in Table 3. The poly(arylene ether), polystyrene-poly(ethylene-butylene)-polystyrene, polystyrene-poly(ethylene-propylene), and citric acid were added at the feed throat of the extruder. The polyamide and filler were added downstream. The conductive carbon black was added after the polyamide and filler. The examples were tested for both in-flow and cross-flow CTE at a temperature range of 30-60° C.

TABLE 3

| | | | | Cross-flow | |
|---|---|---|---|---|---|
| Comparative | | | Flow CTE | CTE | NI |
| Example | Filler | Supplier | (×10⁻⁵° C.⁻¹) | (×10⁻⁵° C.⁻¹) | (kJ/m²⁾ |
| 1 | Talc | Mondo Minerals | 7.1 | 8.5 | 8 |
| | | (Finntalc M15) | | | |
| 2 | Mica | Khaitan Mica Ltd | 7.8 | 8.9 | 6.5 |
| | | (wet grind 60 microns | | | |
| 3 | Graphite | Graphite India | 8 | 9.0 | 6 |
| | | (flaky graphite) | | | |
| 4 | Aramid | Technora | 8 | 10.5 | 9.3 |
| | | (12 micrometer | | | |
| | | diameter, 10 | | | |
| | | millimeter length | | | |
| 5 | Wollastonite | Wolkem | 8.5 | 9.0 | 7.1 |
| | | (Fillex 9AF1 −10 | | | |
| | | micrometer) | | | |
| 6 | Diatomite | Seema Minerals | 8.5 | 9.3 | 7.4 |
| 7 | MWNT | Applied Science, Inc. | 6 | 9.5 | 9.6 |
| | | (PYROGRAF PR-24) | | | |
| 8 | Carbon fiber | Fortafil | 2.6 | 11 | 8.1 |
| | | (F 201) | | | |
| 9 | Glass fiber | NEG | 6.5 | 11 | 12 |
| 10 | Solid glass beads | Sovitec Cataphote | 10 | 10 | 11 |
| | | (MICROPERL) | | | |
| 11 | Alumina | Baikowski | 9 | 10 | 10 |
| | | (BAIKALOX A125) | | | |
| 12 | Boron nitride | LNP USA | 9.4 | 9.5 | 5.2 |
| 13 | Silica | Quartz and Allied | 9.5 | 9.8 | 6 |
| | | Prouducts | | | |
| | | (Universal fumed | | | |
| | | silica) | | | |
| 14 | Milled carbon | Fortafil | 5.2 | 9.8 | 8 |
| | fiber | (F482) | | | |

Comparative Examples 1-14 show that only compositions containing carbon nanotubes, carbon fillers and glass fiber demonstrate a combination of low flow CTE (7×10⁻⁵° C.⁻¹) and NI close to or greater than 10 kJ/m². This is surprising because fillers such as silica, alumina and boron nitride themselves have low CTE values and would be expected to reduce the CTE of the composition.

### Examples 1-2 and Comparative Examples 15-18

Examples were made using the compositions shown in Table 4 and additionally included 0.4 weight percent of a standard additive package. Poly(arylene ether), polystyrene-poly(ethylene-butylene)-polystyrene, polystyrene-poly(ethylene-propylene), and citric acid were added at the feed throat of the extruder. Polyamide, IM and filler were added downstream. The conductive carbon black was added after the polyamide, IM and filler.

The compositions were tested for flow CTE from 23 to 60° C. and NI at 23° C. Results are also shown in Table 4.

TABLE 4

| | CE. | CE | CE | CE | CE | CE | CE | CE | CE | | CE | |
|---|---|---|---|---|---|---|---|---|---|---|---|---|
| | 15 | 16 | 17 | 18 | 19 | 20 | 21 | 22 | 23 | Ex. 1 | 24 | Ex. 2 |
| PPE | 27.1 | 26.1 | 27.1 | 26.1 | 27.1 | 26.1 | 22.1 | 21.1 | 25.8 | 23 | 29.9 | 27.9 |
| PA6 | 10 | 10 | 10 | 10 | 10 | 10 | 10 | 10 | 1010 | 10 | 10 | 10 |
| PA 66 | 38 | 38 | 38 | 38 | 38 | 38 | 38 | 38 | 3838 | 38 | 38 | 38 |
| SEBS | 5.6 | 4.1 | 5.6 | 4.1 | 5.6 | 4.1 | 5.6 | 4.1 | 5.3 | 4.7 | 6.7 | 5.7 |
| SEP | 6.4 | 4.9 | 6.4 | 4.9 | 6.4 | 4.9 | 6.4 | 4.9 | 6.0 | 5.4 | 7.5 | 6.5 |
| CA | 0.7 | 0.7 | 0.7 | 0.7 | 0.7 | 0.7 | 0.7 | 0.7 | 0.7 | 0.7 | 0.7 | 0.7 |
| IM | — | 4 | — | 4 | — | 4 | — | 4 | — | 4 | — | 4 |
| CCB | 1.8 | 1.8 | 1.8 | 1.8 | 1.8 | 1.8 | 1.8 | 1.8 | 1.8 | 1.8 | 1.8 | 1.8 |
| Carbon fiber | — | — | — | — | — | — | — | — | — | — | 5 | 5 |
| Wollastonite | 10 | 10 | — | — | — | — | — | — | — | — | — | — |
| Talc | | | 10 | 10 | — | — | — | — | — | — | — | — |
| Glass fiber | — | | — | — | — | — | — | — | 12 | 12 | — | — |
| Mica | — | | — | — | 10 | 10 | — | — | — | — | — | — |
| Glass beads | — | | — | — | — | — | 15 | 15 | — | — | — | — |
| CTE (×10⁻⁵° C.⁻¹) | 8.5 | 9 | 7.1 | 7.5 | 7.8 | 8.3 | 8.9 | 8.9 | 4.7 | 5.0 | 4.8 | 5.1 |
| NI (kJ/m²) | 7.1 | 9 | 8 | 9 | 6.5 | 8.5 | 6.5 | 9.0 | 11 | 15.8 | 9 | 13.8 |
| Nominal tensile | 18 | 20 | 14 | 16.5 | 14 | 17 | 15.2 | 18 | 8 | 11 | 8 | 10.5 |
| strain at break (%) | | | | | | | | | | | | |

CE = Comparative Example

Comparative Examples 5-22 are compositions containing fillers such as talc, wollastonite, glass beads and mica. Comparative Example 15, 17, 19, and 21 contain only one type of impact modifier and Comparative Examples 16, 18, 20 and 22 contain two types of impact modifier. Comparing the CTE data for Comparative Examples 15-22 shows that the inclusion of an impact modifier having at least two moieties selected from the group consisting of carboxylic acid, anhydride, epoxy, oxazoline and ester call increase the CTE up to 0.5 units but only increases the Notched Izod impact strength up to 2.5 units and none of the Comparative Examples is able to achieve a CTE less than 6 and a Notched Izod strength greater than 10. In contrast, the inclusion of an impact modifier having at least two moieties as described above in compositions comprising glass fiber or carbon fiber (Comparative Example 23, 24 and Examples 1 and 2) results in an increase in Notched Izod strength greater than or equal to 4.8 with only a minimal increase in CTE.

### Examples 3-5 and Comparative Example 19

Examples 3-5 were made as described above with respect to Examples 1-2 and Comparative Examples 15-18. Composition, CTE values, and NI values are shown in Table 5. The composition contained 0.4 weight percent of a standard additive package.

TABLE 5

| | | | | Comp |
|---|---|---|---|---|
| | Ex. 3 | Ex. 4 | Ex. 5 | Ex. 20 |
| PPE | 27.9 | 23 | 25.8 | 34.1 |
| PA6 | 10 | 10 | 10 | 10 |
| PA66 | 38 | 38 | 38 | 38 |
| SEP | 6.5 | 4.7 | 5.3 | 7 |
| SEBS | 5.7 | 5.4 | 6.0 | 8 |
| Citric Acid | 0.7 | 0.7 | 0.7 | 0.7 |
| IM | 4 | 4 | 4 | — |
| CCB | 1.8 | 1.8 | 1.8 | 1.8 |
| Carbon fiber | 5 | — | 5 | — |
| Glass fiber | — | 12 | 3 | — |
| Flow CTE (×10⁻⁵° C.⁻¹) | 5.1 | 5.0 | 4.7 | 10 |
| Notched Izod (kJ/m²) | 13.2 | 15.8 | 14.8 | 20 |
| VST (° C.) | 187 | 189 | 190 | 175 |
| Nominal tensile | 10.5 | 11 | 11 | 33 |
| strain at break (%) | | | | |
| SVR (kOhm · cm) | 1.2 | 32 | 56 | 10 |
| Puncture energy (J) | 31 | 22 | — | 73 |
| Puncture deflection (mm) | 12 | 10 | — | 20 |

Comparative Example 20 contains electrically conductive filler but does not contain fillers to decrease the CTE. Comparative Example 20 has a Notched Izod of 20 kJ/m². Examples 3, 4 and 5 contain fibrous filler and electrically conductive filler and have a CTE that is approximately half or less than half of the CTE of Comparative Example 20. Remarkably, despite reducing the CTE by approximately half, the Notched Izod values of Examples 3-5 are more than half of the Notched Izod value of Comparative Example 20.

### Examples 6-10 and Comparative Examples 20 and 21

Examples 6-10 and Comparative Examples 20 and 21 were made as described above with respect to Examples 1-2 and Comparative Examples 15-18. Composition, CTE values, and Ni values are shown in Table 6. The composition contained 0.4 weight percent of a standard additive package.

TABLE 6

| | CE | Ex. | Ex. | CE | Ex. | Ex. | Ex. |
|---|---|---|---|---|---|---|---|
| | 20 | 6 | 7 | 21 | 8 | 9 | 10 |
| PPE | 29.5 | 29.5 | 28.5 | 22.5 | 22.5 | 21.5 | 22.5 |
| PA6 | 10 | 10 | 10 | 10 | 10 | 10 | 10 |
| PA66 | 38 | 38 | 38 | 38 | 38 | 38 | 38 |
| SEP | 7 | 6 | 5.5 | 7 | 6 | 5.5 | 5.5 |
| SEBS | 8 | 7 | 6.5 | 8 | 7 | 6.5 | 6.5 |
| Citric Acid | 0.7 | 0.7 | 0.7 | 0.7 | 0.7 | 0.7 | 0.7 |
| CCB | 1.8 | 1.8 | 1.8 | 1.8 | 1.8 | 1.8 | 1.8 |
| 1^{st} IM | 0 | 2 | 4 | 0 | 2 | 4 | 4 |
| Carbon fiber | 5 | 5 | 5 | 0 | 0 | 0 | 3 |
| Glass fiber | 0 | 0 | 0 | 12 | 12 | 12 | 8 |
| IM/Fiber | 0 | 0.4 | 0.8 | 0 | 0.2 | 0.3 | 0.5 |
| Flow CTE | 4.8 | 4.9 | 5.1 | 4.7 | 4.9 | 5.0 | 4.7 |
| (×10⁻⁵° C.⁻¹) | | | | | | | |
| Notched Izod (kJ/m²) | 9 | 11 | 13.8 | 10 | 12.5 | 15.8 | 14.8 |
| VST (° C.) | 189 | 188.3 | 187 | 193 | 189 | 189 | 190 |
| Nominal tensile | 8 | 9 | 10.5 | 6.5 | 8 | 11 | 11 |
| strain at break (%) | | | | | | | |

As can be seen from the foregoing examples, having a weight ratio of the first impact modifier to the fibrous filler greater than or equal to 0.2 yields Notched Izod strength greater than or equal to 10 kj/m² and a mean CTE less than or equal to 6.0×10⁻⁵° C.⁻¹.

### Example 11 and Comparative Examples 22 and 23

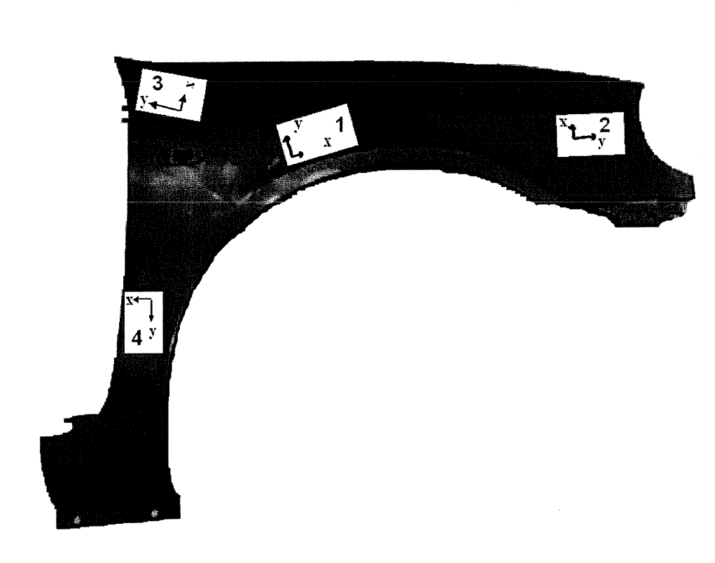

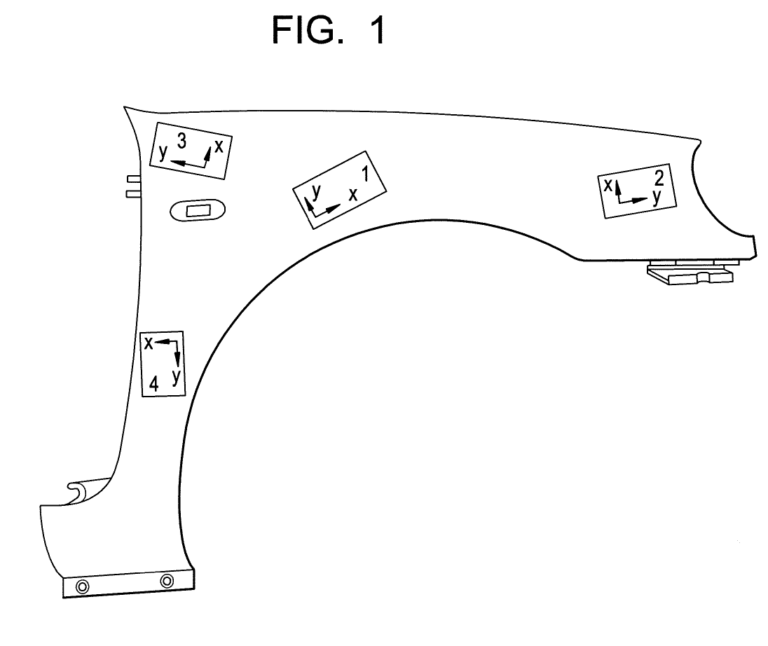

Three compositions were injection molded to form three automotive fenders. Samples were cut from the unpainted fender for linear CTE testing. The location of the samples is shown in FIG. 1. The samples were tested in the x and y directions as shown in FIG. 1. Compositions are shown in Table 7 and results are shown in Table 8.

TABLE 7

| | CE 22 | CE 23 | Ex. 11 |
|---|---|---|---|
| PPE | 34.1 | 25.9 | 28.5 |
| PA6 | 10 | 0 | 10 |
| PA66 | 38 | 50 | 38 |
| SEP | 8 | 0 | 5.5 |
| SEBS | 7 | 5.5 | 6.5 |
| Citric Acid | 0.7 | 0.7 | 0.7 |
| CCB | 1.8 | 1.7 | 1.8 |
| 1^{st} IM | 0 | 0 | 4 |
| Carbon fiber | 0 | 0 | 5 |
| Glass fiber | 0 | 0 | 0 |
| Talc | | 18 | 0 |

TABLE 8

| | CE 22 | CE 23 | Ex. 11 |
|---|---|---|---|
| 1-y | 9.5 | 6.2 | 6.0 |
| 1-x | 9.5 | 6.4 | 6.5 |
| 2-x | 8.6 | 6.3 | 6.2 |
| 2-y | 9.0 | 6.0 | 7.5 |
| 3-x | 8.9 | 5.8 | 7.4 |
| 3-y | 9.5 | 6.0 | 6.0 |
| 4-x | 9.1 | 6.0 | 8.3 |
| 4-y | 9.4 | 6.0 | 5.9 |
| Avg linear CTE | 9.2 | 5.3 | 6.7 |
| (×10⁻⁵° C.⁻¹) | | | |
| Max linear CTE | 9.5 | 6.4 | 8.3 |
| (×10⁻⁵° C.⁻¹) | | | |

Fenders as shown in FIG. 1 made from the compositions of CE 22, CE 23 and Ex. 11 were painted using conventional techniques. The painted fenders were subject to impact testing. A 6 kilogram hammer moved horizontally from a position 165 millimeters from the top of the wheel well on the fender. The fender is mounted on a frame. The hammer is moved at increasing speeds until failure of the fender occurs. Failure is defined as cracking, breaking, shattering or denting on either the painted or unpainted surface. Results are reported as the maximum hammer speed at which no failure occurs. CE 22 and Ex. 11 both had maximum hammer speeds of 12 kilometers per second. CE 23 had a maximum hammer speed less than 10 meters per second.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All patents cited herein are incorporated by reference in their entirety.

1. A method of making a thermoplastic composition comprising
melt blending a poly(arylene ether), a compatibilizer and a second impact modifier comprising aryl alkylene units to form a first mixture;
melt blending the first mixture with a polyamide, a first masterbatch and a second masterbatch wherein
the first masterbatch comprises polyamide and electrically conductive carbon black and
the second masterbatch comprises:
polyamide,
a first impact modifier essentially free of aryl alkylene units and comprising at least two moieties selected from the group consisting of carboxylic acid, anhydride, epoxy, oxazoline and ester, and
a fibrous filler selected from the group consisting of carbon fibers, carbon nanotubes, glass fibers, and combinations of two or more of the foregoing fibrous fillers.

2. The method of claim 1 wherein the first impact modifier comprises:
units derived from ethylene, propylene or a mixture thereof;
units derived from a butyl acrylate, propyl acrylate, hexyl acrylate, butyl methacrylate, propyl methacrylate, hexyl methacrylate or a combination comprising two or more of the foregoing acrylates and methacrylates; and
units derived acrylic acid, maleic anhydride, glycidyl methacrylate or a combination.

3. The method of claim 2 wherein the units derived from acrylic acid, maleic anhydride, glycidyl methacrylate or combination thereof are present in an amount of 2 to 10 weight percent based on the total weight of the first impact modifier.

4. The method of claim 1 wherein the second impact modifier comprises polystyrene-poly(ethylene-butylene)-polystyrene and polystyrene-poly(ethylene-propylene).

5. The method of claim 1 wherein the first impact modifier is present in and amount of 1 to 5 weight percent based on the total weight of the composition.

6. The method of claim 1 wherein the poly(arylene ether) is present in an amount of 15 to 65 weight percent and the polyamide is present in an amount of 30 to 85 weight percent based on the total weight of the composition.

7. A method of making a thermoplastic composition comprising:
melt blending a poly(arylene ether), a compatibilizer, and a second impact modifier comprising aryl alkylene units to form a first mixture;
melt blending the first mixture with a polyamide and a masterbatch to form a second mixture; and
melt blending the second mixture with electrically conductive carbon black wherein the masterbatch comprises polyamide, a first impact modifier essentially free of aryl alkylene units and comprising at least two moieties selected from the group consisting of carboxylic acid, anhydride, epoxy, oxazoline and ester, and a fibrous filler selected from the group consisting of carbon fibers, carbon nanotubes, glass fibers, and combinations of two or more of the foregoing fibrous fillers.

8. The method of claim 7 wherein the first impact modifier comprises:
units derived from ethylene, propylene or a mixture thereof;
units derived from a butyl acrylate, propyl acrylate, hexyl acrylate, butyl methacrylate, propyl methacrylate, hexyl methacrylate or a combination comprising two or more of the foregoing acrylates and methacrylates; and
units derived acrylic acid, maleic anhydride, glycidyl methacrylate or a combination.

9. The method of claim 8 wherein the units derived from acrylic acid, maleic anhydride, glycidyl methacrylate or combination thereof are present in an amount of 2 to 10 weight percent based on the total weight of the first impact modifier.

10. The method of claim 7 wherein the second impact modifier comprises polystyrene-poly(ethylene-butylene)-polystyrene and polystyrene-poly(ethylene-propylene).

11. The method of claim 7 wherein the first impact modifier is present in and amount of 1 to 5 weight percent based on the total weight of the composition.

12. The method of claim 7 wherein the poly(arylene ether) is present in an amount of 15 to 65 weight percent and the polyamide is present in an amount of 30 to 85 weight percent based on the total weight of the composition.
